(19) United States
(12) Patent Application Publication
(10) Pub. No.: US 2026/0369743 A1
(43) Pub. Date: Nov. 19, 2026

(54) BATTERY PACK THERMAL BARRIER ASSEMBLY

(71) Applicant: Ford Global Technologies, LLC, Dearborn, MI (US)

(72) Inventor: Jie Deng, Novi, MI (US)

(21) Appl. No.: 19/557,290

(22) Filed: Mar. 5, 2026

Related U.S. Application Data
(60) Provisional application No. 63/806,787, filed on May 16, 2025.

(51) Int. Cl. H01M 10/658; H01M 10/613; H01M 10/625; H01M 10/6551; H01M 10/6567; H01M 50/249

(52) U.S. Cl. CPC H01M 10/658; H01M 10/613; H01M 10/625; H01M 10/6551; H01M 10/6567; H01M 50/249; H01M 2220/20

(57) ABSTRACT

A thermal barrier for a cell stack of a battery includes a pair of fins configured to be disposed between adjacent battery cells of a cell stack. A single piece of material is disposed between the fins. The single piece of material is smaller than the fins in both a height direction and a width direction. Coolant can move between the fins around the single piece of material.

### CROSS REFERENCE TO RELATED APPLICATIONS

This application claims the benefit of U.S. Provisional Application No. 63/806787, filed May 16, 2025, the entirety of which is herein incorporated by reference.

### TECHNICAL FIELD

This disclosure details exemplary thermal barrier assemblies and more particularly, thermal barrier assemblies having a material between fins that is undersized relative to the fins to permit coolant flow between the fins and about the material.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A battery pack assembly can power the electric machines. As part of an immersion thermal management system, liquid coolant can be moved through the battery pack to help manage thermal energy within the battery pack. Battery pack assemblies can also be used outside of vehicles, such as for non-vehicular energy storage applications.

### SUMMARY

In some aspects, the techniques described herein relate to a thermal barrier for a cell stack of a battery, including: a pair of fins configured to be disposed between adjacent battery cells of a cell stack; and a single piece of material disposed between the fins, wherein the single piece of material is smaller than the fins in both a height direction and a width direction.

In some aspects, the techniques described herein relate to a thermal barrier, where the single piece of material has exposed peripheral surfaces.

In some aspects, the techniques described herein relate to a thermal barrier, wherein the exposed peripheral surfaces are configured to interface directly with liquid coolant.

In some aspects, the techniques described herein relate to a thermal barrier, wherein the exposed peripheral surfaces are radially facing surface with reference to an axis of the cell stack.

In some aspects, the techniques described herein relate to a thermal barrier, wherein the battery cells are within the cell stack, the battery cells disposed along an axis of the cell stack, wherein the exposed peripheral surfaces extends circumferentially continuously about the axis.

In some aspects, the techniques described herein relate to a thermal barrier, wherein the single piece of material is a unitary, monolithic component.

In some aspects, the techniques described herein relate to a thermal barrier, wherein the single piece of material is bounded axially by the fins.

In some aspects, the techniques described herein relate to a thermal barrier, wherein the single piece of material is a mixture of two or more materials.

In some aspects, the techniques described herein relate to a thermal barrier, wherein the single piece of material is mica.

In some aspects, the techniques described herein relate to a thermal barrier, wherein the cell stack is a cell stack of a battery pack.

In some aspects, the techniques described herein relate to a battery pack having a thermal barrier.

In some aspects, the techniques described herein relate to a thermal barrier, wherein each of the fins in the pair of fins has a C-shaped cross-section, the C-shaped cross-sections of the fins open in opposite directions.

In some aspects, the techniques described herein relate to a thermal barrier, wherein the single piece of material is the only discrete material member disposed axially between the fins and the battery cells.

In some aspects, the techniques described herein relate to a thermal barrier, wherein the fins protrude from the cell stack and are configured to support the cell stack at an elevated position within an enclosure assembly.

In some aspects, the techniques described herein relate to a thermal barrier, wherein the fins extend from an enclosure floor to an enclosure cover.

In some aspects, the techniques described herein relate to a thermal barrier, the single piece of material extends both above the battery cells of the cell stack and beneath the battery cells of the cell stack.

In some aspects, the techniques described herein relate to a thermal barrier for a cell stack, including: a pair of fins configured to be disposed between adjacent battery cells of a cell stack; and a single piece of material disposed between the fins, the single piece of material is smaller than the fins in both height and width such that liquid coolant flows circumferentially around the single piece of material between the fins.

In some aspects, the techniques described herein relate to a thermal barrier, wherein the cell stack is thermally managed with an immersion thermal management fluid, wherein the cell stack is within a battery.

In some aspects, the techniques described herein relate to a thermal barrier, wherein the single piece of material is spaced from opposing edges of each fin to define coolant flow paths around an entire perimeter of the single piece.

In some aspects, the techniques described herein relate to a thermal barrier, wherein the single piece of material is mica.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of a battery array from the battery pack of FIG. 1.

FIG. 3 illustrates a section view of the battery array of FIG. 2 showing a portion of a cell stack disposed between an enclosure cover and an enclosure tray.

FIG. 4 illustrates a close-up view of an area of FIG. 3 showing thermal barrier assemblies according to an exemplary embodiment of the present disclosure.

FIG. 5 illustrates one of the thermal barrier assemblies from FIG. 4.

FIG. 5A illustrates a thermal barrier according to another exemplary embodiment of the present disclosure.

FIG. 5B illustrates a thermal barrier according to another exemplary embodiment of the present disclosure.

FIG. 6 illustrates a perspective view of a thermal barrier assembly from the battery array of FIG. 5.

FIG. 7 is an expanded view of the thermal barrier assembly of FIG. 6.

### DETAILED DESCRIPTION

An immersion thermal management system can be used to manage thermal conditions within a battery pack. In such systems, at least a portion of the battery pack—including, in some embodiments, a cell stack—can be immersed in a liquid coolant. Thermal barrier assemblies may be incorporated within the cell stack to define regions or compartments within the battery pack and to help manage conditions during venting events.

The example electrified vehicle 10 is an all-electric vehicle. In other examples, the electrified vehicle 10 is a hybrid electric vehicle, which can selectively drive wheels using torque provided by an internal combustion engine instead of, or in addition to, an electric machine. The electrified vehicle 10 could be an extended-range electric vehicle (EREV) in which an internal combustion engine is operated to recharge the traction battery while the wheels are driven by an electric machine. Further, while the exemplary battery pack 14 is shown and described in connection with energy storage on the electrified vehicle 10, the battery pack 14 could be used for non-vehicular energy storage. For example, the battery pack 14 could be part of a battery energy storage system (BESS).

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

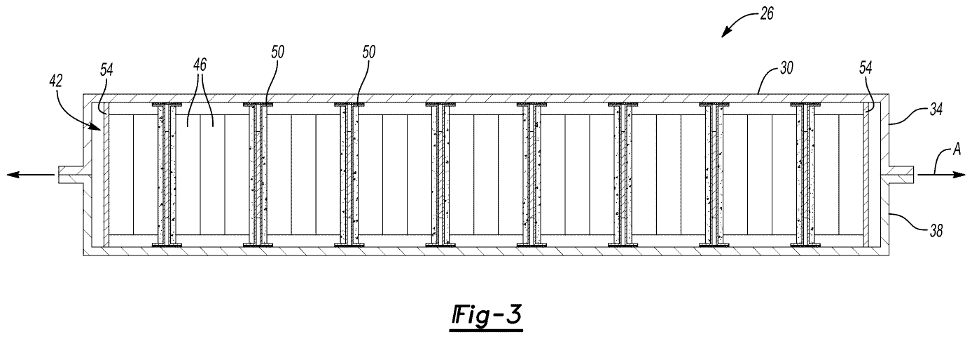

FIGS. 2 and 3 illustrate additional detail of one of the battery arrays 26 from the example battery pack 14. The remaining battery arrays 26 of the battery pack 14 can be similarly constructed. The battery pack 14 is schematically shown as including six battery arrays 26, but the battery pack 14 could include other numbers of battery arrays 26 in other examples.

In this example, the battery array 26 includes an array enclosure assembly 30, which includes an enclosure cover 34 and an enclosure tray 38. The enclosure cover 34, in this example, is vertically above the enclosure tray 38. In other examples, however, the enclosure cover 34 could be arranged below, or to a side of the enclosure tray 38.

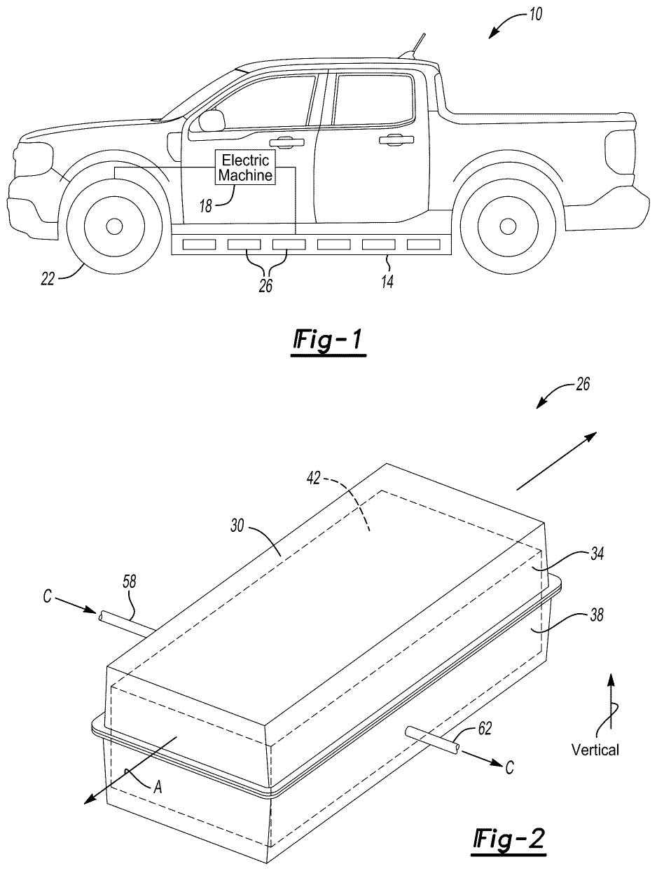

Various terms such as “vertical,” “above,” “below,” “top,” and “bottom” are used relative to the arrangement of the components of the battery array 26 in the various drawings and should not otherwise be deemed limiting. These terms are with reference to the general orientation of the battery array 26 when installed within the electrified vehicle 10 of FIG. 1.

The enclosure cover 34 is welded to the enclosure tray 38 in one example of this disclosure. While welding is mentioned, the enclosure cover 34 and enclosure tray 38 could be connected using other types of fluid-tight connections, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A together with a plurality of thermal barrier assemblies 50.

Each of the thermal barrier assemblies 50 is disposed between groups of the battery cells 46 along the cell stack axis A. Each of the groups of battery cells 46 includes two or three individual battery cells 46 in this example. The groups could include other numbers of battery cells 46 in other examples. The battery cells 46 and thermal barrier assemblies 50 can be compressed along the cell stack axis A between a pair of endplates 54.

The cell stack 42 could include any number of battery cells 46. The battery array 26 could employ any number of cell stacks 42 within the enclosure assembly 30. Thus, this disclosure is not limited to the exact configuration shown in FIGS. 2-3.

Further, while the battery cells 46 and thermal barrier assemblies 50 of FIG. 3 are positioned side-by-side relative to one another, other configurations are also contemplated within the scope of this disclosure, including but not limited to embodiments in which the battery cells 46 and thermal barrier assemblies 50 are stacked on top of one another, for example.

In an embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The cell stack 42 is arranged in the interior of the enclosure assembly 30 between the enclosure tray 38 and the enclosure cover 34. A thermal management system is used to manage thermal energy levels within the battery pack 14. The example thermal management system is configured to route non-conductive (i.e., dielectric) liquid coolant C over areas of the cell stack 42 to manage thermal energy within the cell stack 42 by, for example, using the coolant C to take on heat from the cell stack 42.

The thermal management system is an immersion thermal management system at least because portions of the battery pack 14, here at least the battery cells 46 of the cell stack 42 are immersed in the coolant C, which can be considered an immersion thermal management fluid.

In this example, the coolant C generally flows from an inlet 58, on a first side of the cell stack 42, through the interior of the enclosure assembly 30, to an outlet 62 on an opposite, second side of the cell stack 42.

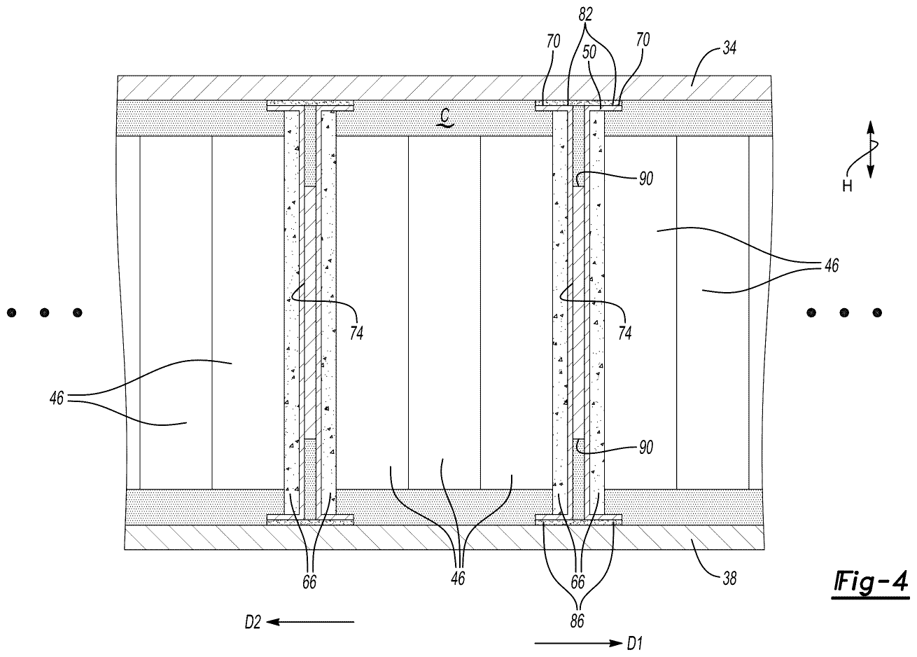

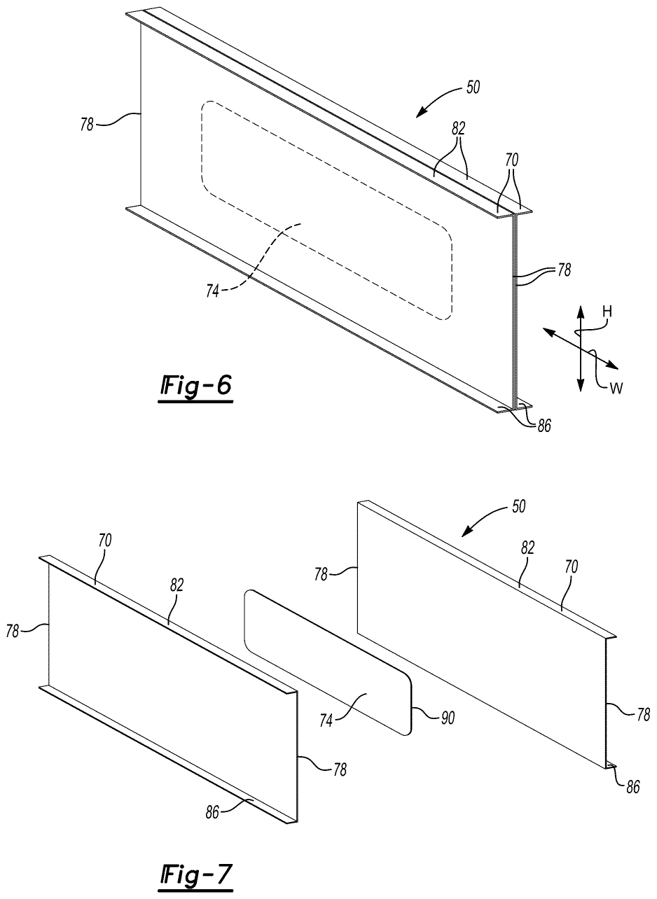

With reference now to FIGS. 4-6, and continuing reference to FIGS. 2 and 3, the thermal barrier assemblies 50, in the exemplary embodiment, are disposed axially between outer layers 66, which could be compressible layers of foam, for example. The outer layers 66 can compress to accommodate expansion of the battery cells 46 over time. In other examples, the outer layers 66 could be omitted.

The thermal barrier assembles 50 each include a pair of fins 70 and a single piece of material. In each of the thermal barrier assemblies 50, the material 74 is disposed between the fins 70 such that the material 74 is bounded axially by the fins 70. In the exemplary embodiment, the single piece of material 74 is the only discrete material member disposed axially between the fins 70 and the battery cells 46.

The fins 70 extend through the cell stack 42 between axially adjacent battery cells 46 of the cell stack 42. The fins 70 protrude vertically above the cell stack 42 and are bonded to an underside of the enclosure cover 34. The fins 70 protrude vertically beneath the cell stack 42 and are bonded to a floor of the enclosure tray 38. The fins 70 support the cell stack 42 at an elevated position within the enclosure assembly 30 so that coolant is able to move above the cell stack 42 and beneath the cell stack 42.

The fins 70 can be a metal or metal-alloy. The fins 70 are aluminum in some examples. Portions of the fins 70 are exposed to the coolant C. The fins 70 can be considered thermal fins that aid in the transfer of thermal energy between the coolant C and the cell stack 42.

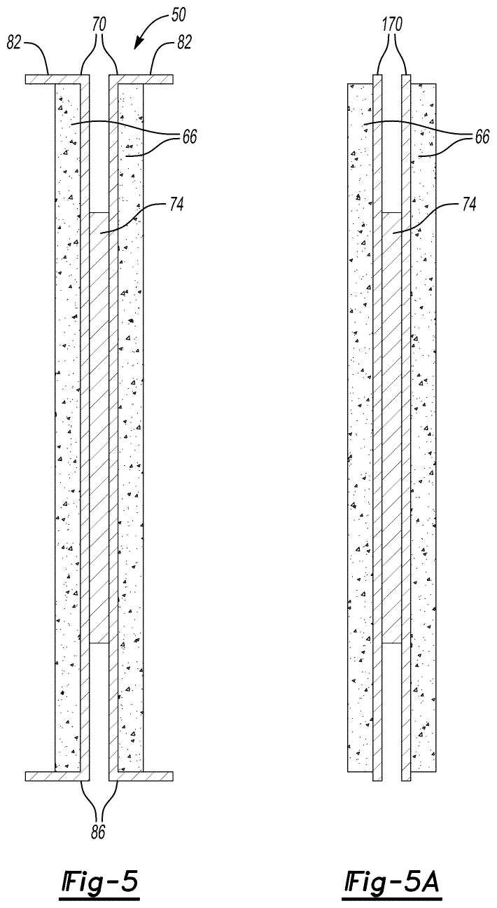

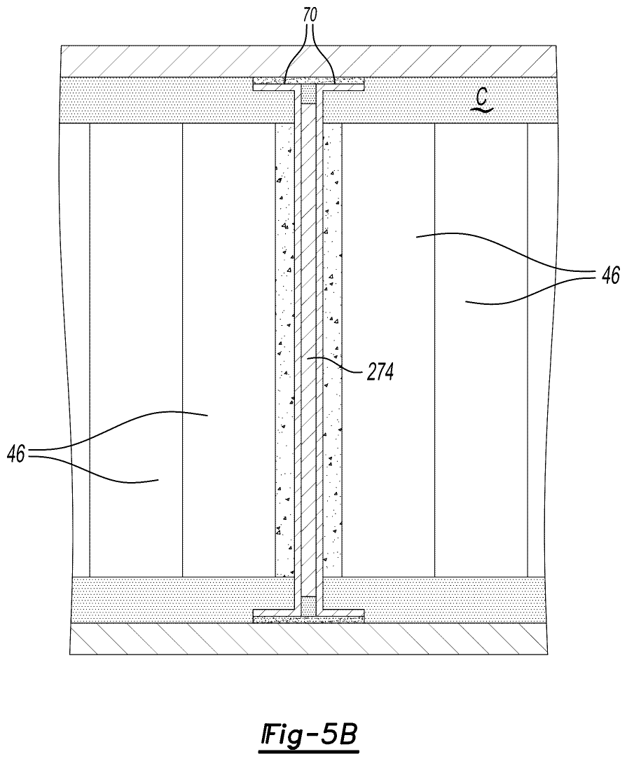

The example fins 70 of the thermal barriers 50 each have a C-shaped cross-section with axially extending flanges 76. One of the fins 70 opens in a first direction D1 along the axis A, and the other fin 70 opens in an opposite direction D2 along the axis A. In other examples, a divider 150 could include the fins 170 that are not C-shaped and omit the flanges 76 (see FIG. 5A).

The material 74 is smaller than the fins 70 in a width direction W such that the material 74 is spaced from opposing outer edges 78 of each of the fins 70. In this example, the material 74 is spaced inward ten millimeters from each of the outer edges 78.

The material 74 is also smaller than the fins 70 in both a height direction H such that the material 74 is recessed relative to both upper edges 82 and lower edges 86 of the fins 70. In this example, the material 74 is recessed ten millimeters from the upper edges 82 and from the lower edges 86. That is, the fins 70 extend laterally beyond the material 74 in both the height direction H and the width direction W. The height direction H and the width direction W each extend radially with respect to the cell stack axis A. The height direction H is a vertical direction.

In this example, the single piece of material 74 does not extend vertically above the battery cells 46 of the cell stack 42 or beneath the battery cells 46 of the cell stack 42. In other examples, a single piece of material 274 extends both above the battery cells 46 of the cell stack 46 and beneath the battery cells 46 of the cell stack 46 (see FIG. 5B).

As the material 74 is undersized relative to the fins 70, there is an open coolant channel that is between the fins 70 but extends circumferentially about the material 74. Coolant C can move between the fins 70 circumferentially continuously about the material 74. That is, the coolant C can form a continuous loop surrounding the material 74 while remaining between the fins 70. Spacing the material from the outer edges 78, the upper edges 82, and the lower edges 86 defines coolant flow paths about an entire perimeter of the fins 70 that is axially between the fins 70 and the battery cells 46.

The material 74 has exposed peripheral surfaces 90 between the fins 70. The exposed peripheral surfaces 90 interface direct with the coolant C. The exposed peripheral surfaces 90 face radially with respect to the cell stack axis A. The exposed peripheral surfaces 90 extend circumferentially continuously about the axis A.

In the exemplary embodiment, the material 74 is substantially centered vertically between the upper edges 82 and lower edges 86 of the fins 70 and substantially centered horizontally between the outer edges 78. This positioning can help to reduce pressure gradients across the axially facing sides of the battery cells 46 when the battery cells 46 expand axially against the fins 70.

As the peripheral surfaces 90 are exposed to coolant C circulating within the interior of the enclosure assembly 30 between the fins 70, The material 74 can be selected to be a material that is compatible with exposure to the coolant C.

The material 74 is a unitary, monolithic component. The material 74 is mica in this example. In another example, the material 74 is foam. The material 74 could be composite sheet with, for example, a layer of foam and a layer of mica. The material 74 could be a mixture of two or more materials. That is, the single piece of material can be a single piece that includes two or more materials The two or more materials could be mixed. The two or more materials could be in different layers.

The example thermal barrier assembly 50 uses the mica as the material 74 that is between fins 70, with outer layers 66 that are foam on both sides. In this example, a height and width of the outer layers 66 is greater than the height and width of the material 74.

In another example, the material 74 between the fins 70 could be foam, and the outer layers 66 could be mica. In some examples, the outer layers 66 could be omitted such that the fins 70 interface directly with the battery cells 46 with the material 74 between those fins 70.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A thermal barrier for a cell stack of a battery, comprising:
a pair of fins configured to be disposed between adjacent battery cells of a cell stack; and
a single piece of material disposed between the fins, wherein the single piece of material is smaller than the fins in both a height direction and a width direction.

2. The thermal barrier of claim 1, where the single piece of material has exposed peripheral surfaces.

3. The thermal barrier of claim 2, wherein the exposed peripheral surfaces are configured to interface directly with liquid coolant.

4. The thermal barrier of claim 2, wherein the exposed peripheral surfaces are radially facing surface with reference to an axis of the cell stack.

5. The thermal barrier of claim 4, wherein the battery cells are within the cell stack, the battery cells disposed along an axis of the cell stack, wherein the exposed peripheral surfaces extends circumferentially continuously about the axis.

6. The thermal barrier of claim 1, wherein the single piece of material is a unitary, monolithic component.

7. The thermal barrier of claim 1, wherein the single piece of material is bounded axially by the fins.

8. The thermal barrier of claim 1, wherein the single piece of material is a mixture of two or more materials.

9. The thermal barrier of claim 1, wherein the single piece of material is mica.

10. The thermal barrier of claim 1, wherein the cell stack is a cell stack of a battery pack.

11. A battery pack of an electrified vehicle, the battery pack including the thermal barrier of claim 1.

12. The thermal barrier of claim 1, wherein each of the fins in the pair of fins has a C-shaped cross-section, the C-shaped cross-sections of the fins open in opposite directions.

13. The thermal barrier of claim 1, wherein the single piece of material is the only discrete material member disposed axially between the fins and the battery cells.

14. The thermal barrier of claim 1, wherein the fins protrude from the cell stack and are configured to support the cell stack at an elevated position within an enclosure assembly.

15. The thermal barrier of claim 1, wherein the fins extend from an enclosure floor to an enclosure cover.

16. The thermal barrier of claim 1, wherein the single piece of material extends both above the battery cells of the cell stack and beneath the battery cells of the cell stack.

17. A thermal barrier for a cell stack, comprising:
a pair of fins configured to be disposed between adjacent battery cells of a cell stack; and
a single piece of material disposed between the fins, the single piece of material is smaller than the fins in both height and width such that liquid coolant flows circumferentially around the single piece of material between the fins.

18. The thermal barrier of claim 17, wherein the cell stack is thermally managed with an immersion thermal management fluid, wherein the cell stack is within a battery.

19. The thermal barrier of claim 17, wherein the single piece of material is spaced from opposing edges of each fin to define coolant flow paths around an entire perimeter of the single piece.

20. The thermal barrier of claim 17, wherein the single piece of material is mica.
